(19) United States
(12) Patent Application Publication
(10) Pub. No.: US 2014/0201173 A1
(43) Pub. Date: Jul. 17, 2014

(54) FILE-BASED SOCIAL RECOMMENDATIONS IN A SOCIAL NETWORK

(71) Applicant: HEWLETT-PACKARD DEVELOPMENT COMPANY, L.P., Fort Collins, CO (US)

(72) Inventors: Eyal Roth, Yehud (IL); Olga Tubman, Rishon Le-Tzion (IL); Boris Korenfeld, Rishon Le-Tzion (IL)

(73) Assignee: HEWLETT-PACKARD DEVELOPMENT COMPANY, L.P., Fort Collins, CO (US)

(21) Appl. No.: 13/741,909

(22) Filed: Jan. 15, 2013

(51) Int. Cl. G06F 17/30

(52) U.S. Cl. CPC G06F 17/3053
USPC 707/693; 707/749; 707/697; 707/770

(57) ABSTRACT

Example embodiments relate to file-based social recommendations. In example embodiments, a system may search a social network to identify uploaded files that are similar to a file from a user and then identify unconnected users that uploaded the uploaded files, where the unconnected users are not connected to the user in the social network. In response to identifying the unconnected users, the system may then communicate a user recommendation that at least one unconnected users be added to the social context.

### BACKGROUND

In some scenarios, a user may desire to share documents with other users in a conversation of a social network. For example, the user may upload a document so that other users in the conversation can review the document. Other services also exist to enable collaboration and document sharing between users. In another example, users may create document shares and then expose the document shares to a selected set of users. Typically, the user that owns the document share designates who may access the documents, and the access to the documents is limited by permissions specified by the user.

### BRIEF DESCRIPTION OF THE DRAWINGS

The following detailed description references the drawings, wherein:

FIG. 1 is a block diagram of an example server computing device for providing file-based social recommendations;

FIG. 2 is a block diagram of an example user computing device for receiving and processing file-based social recommendations;

FIG. 3 is a block diagram of an example server computing device in communication with a user computing device and a directory server for providing file-based social recommendations;

FIG. 4A is a flowchart of an example method for execution by a server computing device for providing file-based social recommendations;

FIG. 4B is a flowchart of an example method for execution by a user computing device for receiving and processing file-based social recommendations;

FIG. 5 is a flowchart of an example method for execution by a server computing device for providing file-based social recommendations; and

FIG. 6 is a diagram of an example user interface of a social networking application in which a panel including a conversation has been displayed.

### DETAILED DESCRIPTION

As detailed above, social networking applications enable users to share documents with each other. For example, suppose a user wishes to share an unfamiliar document with a co-worker during a chat conversation, but the co-worker is also unfamiliar with the document. To address this issue, the user may search for additional co-workers in his list of known contacts for other individuals that may have some knowledge of the document. The user may also search other sources such as an email directory or a portal site to identify individuals that have knowledge of the document.

Various social networking applications may be used to facilitate communication between users. For example, a social network may enable users to chat or to hold voice over IP (VOIP) calls on an intranet, where user information for the social network is obtained from a directory service provided by a directory server. In this manner, the user base of the social network may be restricted to the employees of a particular company or even further to the members of a particular group within a company that have access to an enterprise local area network.

In another scenario, document management applications may enable users to share documents and other content with each other. Specifically, a user may upload a document that is shared with his co-workers on, for example, an intranet portal. In this example, the user may specify permissions to restrict the access of his co-workers; however, the user's ability to select co-workers familiar with the document is still restricted by the user's knowledge of his co-workers' knowledge and experience. Further, the user may search for similar documents in the intranet portal, which typically provide content-based keyword search capabilities. As a result, even though search capabilities are provided, an overabundance of information and unrelated documents with similar keywords may prevent the user from easily identifying similar documents.

Example embodiments disclosed herein address these issues by providing file-based social recommendations that are based on similarities determined by comparing representations of data blocks storing the uploaded files. For example, in some embodiments, a server computing device maintains file data describing files that have been uploaded to a social network. When a new file is uploaded by a user to a social context (e.g., conversation, VOIP call, shared desktop, etc.) on the social network, the server computing devices searches for similar files in the file data by comparing representations (e.g., file checksums, compact representations) of the new file and the previously uploaded files. Social recommendations are generated for a user computing device based on the similar files, where the recommendations may suggest that the user (1) add a user that uploaded one of the similar files to the social context; (2) add one of the similar files to the social context; or (3) join a different social context that is related to one of the similar files. In response to the user confirming at least one of the social recommendations, the user computing device may then update a display of the social context according to the confirmed recommendations.

In this manner, example embodiments disclosed herein simplify the discovery and addition of relevant documents or users to a social context in a social network. Specifically, by comparing representations of data blocks to search for similar files, social recommendations may be dynamically provided to a user in response to a file being uploaded to a social context. Furthermore, because the search is not limited to social connections of the user in the social network, the social recommendations may allow the user to discover previously unknown users that are interacting with similar documents.

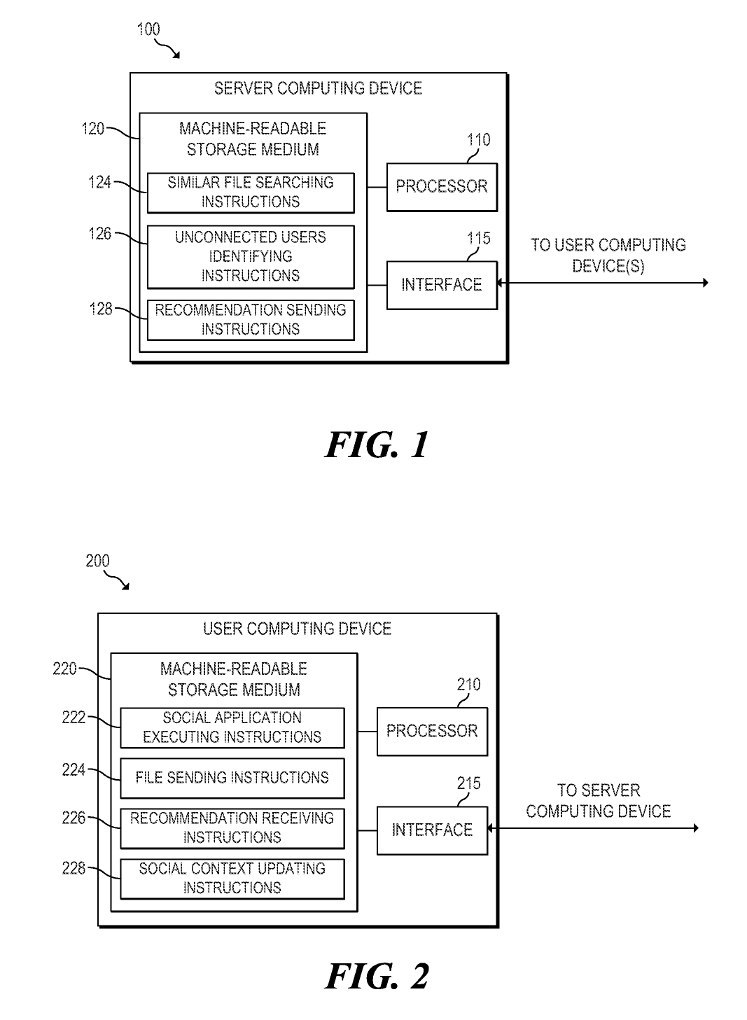

Referring now to the drawings, FIG. 1 is a block diagram of an example server computing device 100 for file-based social recommendations. Server computing device 100 may be any computing device accessible to a user computing device, such as user computing device 200 of FIG. 2. In the embodiment of FIG. 1, server computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 124, 126, 128 to enable file-based social recommendations, as described below. As an alternative or in addition to retrieving and executing instructions, processor 110 may include one or more electronic circuits comprising a number of electronic components for performing the functionality of one or more of instructions 124, 126, 128.

Interface 115 may include a number of electronic components for communicating with a user computing device. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the user computing device. Alternatively, interface 115 may be a wireless interface, such as a wireless local area network (WLAN) interface or a near-field communication (NFC) interface. In operation, as detailed below, interface 115 may be used to send and receive data, such as a social recommendation, a file, and social context data, to and from a corresponding interface of a user computing device.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for providing file-based social recommendations.

Similar file searching instructions 124 may use a file received from a user to search for similar files that were previously uploaded to the social network. Specifically, the file may be received from a user computing device of the user. For example, the user of the user computing device may connect to the server computing device 100 through the interface 115. The user computing device may then provide a file to the server computing device 110 for inclusion in a social context of a social network. The file received from the user computing device may be, for example, a document (e.g., spreadsheet, word processing, presentation, etc.) or media (e.g., video, audio, image, etc.). After receiving the file from the user computing device, the received file may then be stored in a storage device accessible to server computing device 100. The social context may then be updated in the social network to include the received file. Specifically, the social context may be updated by providing, via the interface 115, the file to other user computing devices participating in the social context.

The social context may be a social networking service that facilitates interactions between users in a social network. For example, the social context may be an IM conversation between at least two users. As another example, the social context may be a VOIP phone conference between at least two users. As yet another example, the social context may be a desktop sharing session providing at least one user with access to the sharing user's computer desktop. As yet another example, the social context may be a video conference between at least two users.

At this stage, similar file searching instructions 124 may generate a representation (e.g., checksum, compact representation, etc.) of the received file and then use the representation to search for similar files in the social network. For example, a file checksum may be generated for the received file and then used to search for previously uploaded files that have matching file checksums. In this case, a matching file checksum indicates that the previously uploaded file is identical to the received file. In another example, a compact representation may be generated for the received file and then used to search for previously uploaded files that have compact representations that share at least one feature with the compact representation of the received file.

Unconnected users identifying instructions 126 may then identify unconnected users that uploaded the similar files, where the unconnected users are unconnected to the user in the social network (i.e., the unconnected users are not friends of or linked to the user in the social network). Specifically, the unconnected users may be identified by searching file data that describes the users and social contexts associated with the previously uploaded files. Further, additional information (e.g., email address, phone number, username, etc.) describing the unconnected users may be retrieved from a directory service provided by a directory server. In this case, the social network may be configured to provide communication services (e.g., instant messaging (IM), VOIP calls, desktop sharing, video conferencing, etc.) between users of the directory service.

At this stage, recommendation sending instructions 128 may generate and send social recommendations to the user computing device. Specifically, the social recommendations may be generated based on (1) the similar files; (2) the unconnected users; and/or (3) the social contexts associated with the similar files. For example, the recommendation sending instructions 128 may generate a user recommendation that the user add an unconnected user to the social context currently displayed on the user computing device. In another example, the recommendation sending instructions 128 may generate a file recommendation that the user add a similar file to the social context currently displayed on the user computing device.

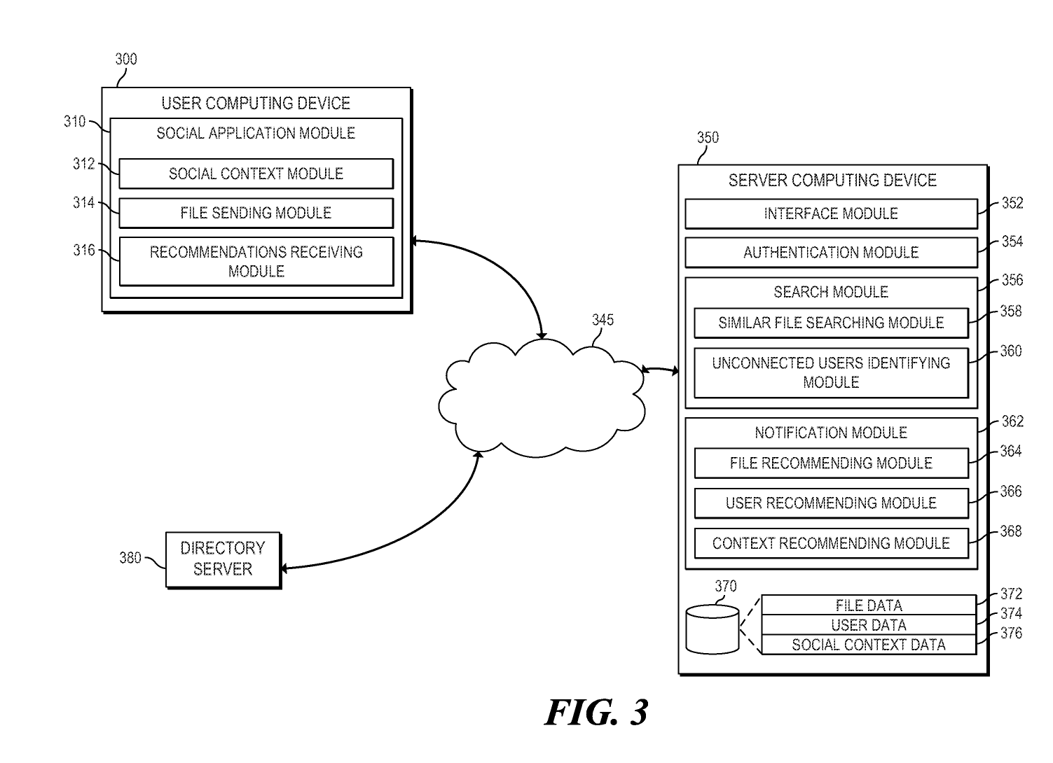

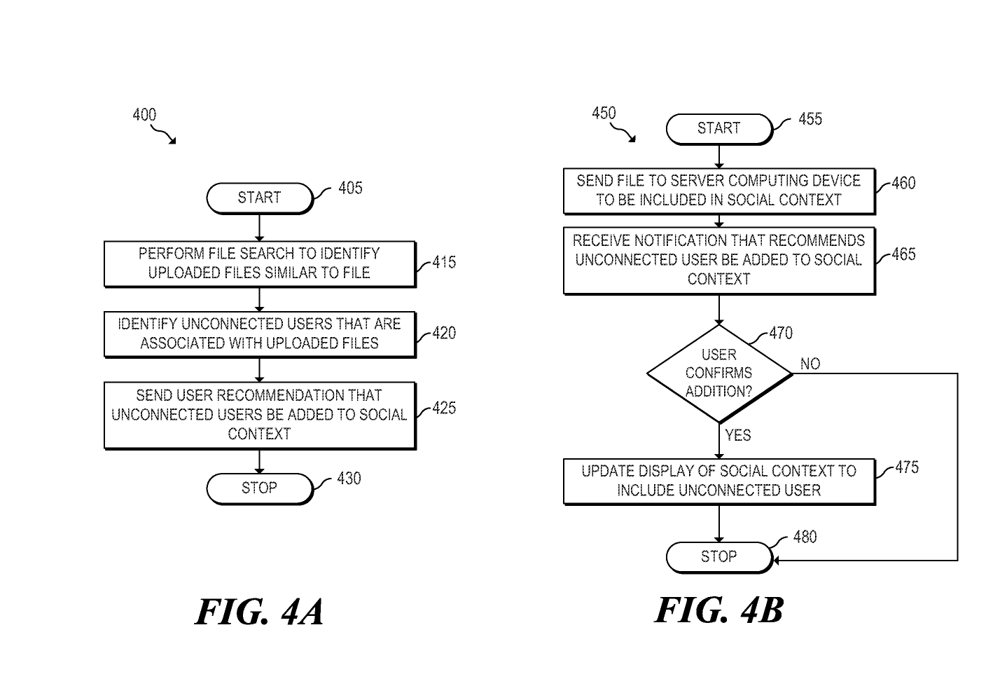

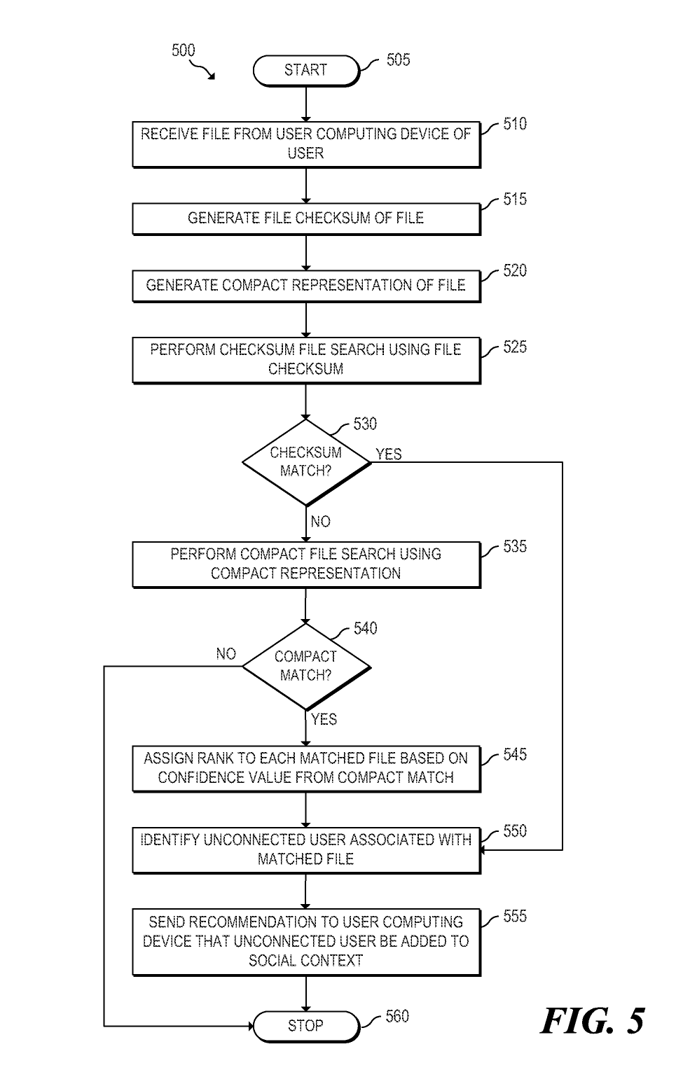

In response to receiving the social recommendations, the user computing device may send confirmation of the social recommendations to the server computing device 100, as discussed below with respect to FIGS. 2 and 4B. The server computing device 100 may then update the social context according to the confirmed social recommendations, as discussed below with respect to FIGS. 3 and 5.

FIG. 2 is a block diagram of an example user computing device 200 for receiving and processing file-based social recommendations from a server computing device. User computing device 200 may be, for example, a notebook computer, a desktop computer, an all-in-one system, a thin client, a workstation, a tablet computing device, a mobile phone, or any other computing device suitable for execution of the functionality described below. In the embodiment of FIG. 2, user computing device 200 includes processor 210, interface 215, and machine-readable storage medium 220.

As with processor 110 of FIG. 1, processor 210 may be one or more CPUs, microprocessors, and/or other hardware devices suitable for retrieval and execution of instructions. Processor 210 may fetch, decode, and execute instructions 222, 224, 226, 228 to implement the receiving and processing of file-based social recommendations described below. Processor 210 may also or instead include electronic circuitry for performing the functionality of one or more instructions 222, 224, 226, 228. As with interface 115 of FIG. 1, interface 215 may include electronic components for wired or wireless communication with server computing device. As described above, interface 215 may be in communication with a corresponding interface of server computing device to send or receive social recommendations, files, or social context data. As with storage medium 120 of FIG. 1, machine-readable storage medium 220 may be any physical storage device that stores executable instructions.

Social application executing instructions 222 may initially provide social networking services to a user of the user computing device 200. For example, the social application executing instructions 222 may display a social context (e.g., IM conversation, video conference, shared desktop, etc.) of a social network on a display screen of the user computing device 200. The social application executing instructions 222 may also allow the user to upload files (e.g., documents, media, etc.) to the social context provided by the server computing device. In this example, the user may initiate an upload of a file to the server computing device by selecting a file that is stored locally on the user computing device 200.

File sending instructions 224 may send the file selected to be uploaded by the user to the server computing device via the interface 215. The file may be sent to the server computing device so that the file can be included in the social context currently displayed on the user computing device 200. The uploaded file may then be processed by the server computing device 100 to generate social recommendations, as discussed with respect to FIGS. 1 and 4A.

Recommendation receiving instructions 226 may then receive social recommendations from the server computing device via the interface 215. The social recommendations may include user recommendations, file recommendations, and/or social context recommendations. For example, the social recommendations may include a user recommendation that the user add an unconnected user who uploaded a similar file to the file uploaded by the user to the social context currently displayed on the user computing device 200. As another example, the social recommendations may include a file recommendation that the user add a similar file to the file uploaded by the user to the social context currently displayed on the user computing device 200. As yet another example, the social recommendations may include a context recommendation that the user join a related social context that includes a similar file to the file uploaded by the user. The recommendations receiving instructions 226 may also update the display of the social context to notify the user of the social recommendations.

Social context updating instructions 228 may receive confirmation of at least one of the social recommendations from the user. For example, the user may confirm that he wishes to add an unconnected user to the social context currently displayed on the user computing device 200. In response to receiving the confirmation, the social context updating instructions 228 may send a request to the server computing device to add the unconnected user to the social context. After the social context is updated, the social context updating instructions 228 may update the display of the social context on the user computing device 200 to include the unconnected user. In another example, a similar the included in a the recommendation may be added to the social context by the social context updating instructions 228 in response to the file recommendation being confirmed.

FIG. 3 is a block diagram of an example server computing device 350 in communication via a network 345 with a user computing device 300 and a directory server 380. As illustrated in FIG. 3 and described below, server computing device 350 may communicate with user computing device 300 to provide social recommendations for a social network.

As illustrated, user computing device 300 may include a number of modules 310-316, while server computing device 350 may include a number of modules 352-368. Each of the modules may include a series of instructions encoded on a machine-readable storage medium and executable by a processor of the respective device 300, 350. In addition or as an alternative, each module may include one or more hardware devices including electronic circuitry for implementing the functionality described below.

As with user computing device 200 of FIG. 2, user computing device 300 may be a notebook, desktop, tablet, workstation, mobile device, or any other device suitable for executing the functionality described below. As detailed below, user computing device 300 may include a series of modifies 310-316 for enabling a user to receive and process file-based social recommendations.

Social application module 310 may provide a user with access to social networking services provided by the server computing device 350. Although the components of social application module 310 are described in detail below, additional details regarding an example implementation of module 310 are provided above in connection with instructions 222-228 of FIG. 2.

Social context module 312 may present a social context (e.g., conversation, video conference, VOIP call, shared desktop, etc.) of the social network as provided by the server computing device 350. For example, the social context module 312 may present a conversation that has been initiated by the user with another user on the social network. The social context module 312 may allow the users to share instant messages with each other, which are tracked in the conversation displayed by the user computing device 300. Further details regarding an example implementation of social context module 312 are provided above in connection with social application executing instructions 222 and social context updating instructions 228 of FIG. 2.

File sending module 314 may send files that are selected to be uploaded by the user to the server computing device 350. In this case, the social context module 312 may allow the user to select a file (e.g., document, media) to be uploaded to a social context that is currently displayed on the user computing device 300. After the file is selected by the user, the file sending module 314 may send a request to the server computing device 350 that the file be added to the social context. The file sending module 314 may then confirm that the file was added to the social context and instruct the social context module 312 to update the display of the social context to include the file. Further details regarding an example implementation of file sending module 314 are provided above in connection with file sending instructions 224 of FIG. 2.

Recommendations receiving module 316 may receive and process social recommendations from the server computing device 350. The social recommendations may include recommendations to (1) add an unconnected user to the currently displayed social context; (2) add a similar file to the currently displayed social context; and/or (3) add the user to a different social context that is associated with a similar file. In response to the social recommendations, the recommendations receiving module 316 may provide the social recommendations to the social context module 312 so that the social context may be updated to notify the user of the social recommendations. If the user confirms at least one of the social recommendations, the social context module 312 may then update the social context according to the confirmed social recommendations. Further details regarding an example implementation of recommendations receiving module 316 are provided above in connection with recommendation receiving instructions 226 of FIG. 2.

As with server 100 of FIG. 1, server computing device 350 may be any server accessible to user computing device 300 over a network 345 that is suitable for executing the functionality described below. As detailed below, server computing device 350 may include a series of modules 352-368 for providing social recommendations to user computing devices.

Interface module 352 may manage communications with the user computing device 300. Specifically, the interface module 352 may initiate connections with the user computing device 300 and then send or receive social context data to the user computing device 300. Interface module 352 may also process login credentials of a user to authorize access by the user computing device 300 to the server computing device 350. Specifically, the interface may first request login information from the user and, upon receipt of the login information, request that authentication module 354 determine whether the user is properly authenticated. If the user is properly authenticated, interface module 352 may then present an additional interface that allows the user to access social networking services provided by the server computing device 350. The authentication module 354 may use a directory service provided by the directory server 380 to determine whether the user is properly authenticated.

Search module 356 may manage the process for performing file-based searches of the social network. Although the components of search module 356 are described in detail below, additional details regarding an example implementation of search module 356 are provided above in connection with similar file searching instructions 124 and unconnected users identifying instructions 126 of FIG. 1.

Similar file searching module 358 may search for similar files in response to an uploaded file received from the user computing device 300. The similar file searching module 358 may generate a representation of the uploaded file and then search for similar files using the representation. For example, a file checksum may be generated for the uploaded file and then used to find matching file checksums of previously uploaded files in file data 372 of storage device 370. In this case, a matching file checksum indicates that the previously uploaded the is identical to the uploaded file. In another example, a compact representation may be generated for the uploaded file and then used to search in the file data 372 for previously uploaded files that have compact representations that share at least one feature with the compact representation of the uploaded file.

Unconnected users identifying module 360 may identify unconnected users that uploaded the similar files identified by the similar the searching module 358, where the unconnected users are unconnected to the user in the social network (i.e., the unconnected users are not friends of or linked to the user in the social network). Specifically, the unconnected users may be identified based on data records in the file data 372 describing the users and social contexts associated with the previously uploaded files. Further, additional information (e.g., email address, phone number, username, etc.) describing the unconnected users may be retrieved from user data 374 of the storage device 370.

Notification module 362 may manage the process for generating social recommendations. Although the components of notification module 362 are described in detail below, additional details regarding an example implementation of notification module 362 are provided above in connection with recommendation sending instructions 128 of FIG. 1.

File recommending module 364 may generate file recommendations that a user should add at least one of the similar files identified by the similar file searching module 358 to a social context. For example, the file recommending module 364 may generate a file recommendation that the user add a similar file to a social context displayed on the user computing device 300. In this example, the similar file may be identical or similar to a file shared by the user in the social context. If the file recommendation is confirmed by the user, the file recommending module 364 may update social context data 376 of the storage device 370 so that the social context includes the similar file.

User recommending module 366 may generate user recommendations that a user should add at least one of the users that have uploaded similar files identified by the similar file searching module 358 to a social context. For example, the user recommending module 366 may generate a user recommendation that the user add an unconnected user to a social context displayed on the user computing device 300. In this example, the unconnected user may have uploaded an identical or similar file to a file shared by the user in the social context. If the user recommendation is confirmed by the user, the user recommending module 366 may update the social context data 376 so that the social context includes the unconnected user.

Context recommending module 368 may generate context recommendations that a user should join a related social context that includes a similar file identified by the similar file searching module 358. For example, the context recommending module 368 may generate a context recommendation that the user join a related social context that includes an identical or similar file identified by the similar file searching module 358. If the context recommendation is confirmed by the user, the context recommending module 368 may update the social context data 376 so that the related social context includes the user.

Storage device 370 may be any hardware storage device for maintaining data accessible to server computing device 350. For example, storage device 370 may include one or more hard disk drives, solid state drives, tape drives, and/or any other storage devices. The storage devices may be located in server computing device 350 and/or in another device in communication with server computing device 350. As detailed above, storage device 370 may maintain file data 372, user data 374, and social context data 376.

Directory server 380 may be any computing device suitable for providing a directory service to server computing device 350. For example, directory server 380 may maintain a directory of users that are members of an enterprise local area network. Upon receipt of a request from server computing device 350 that identifies a particular user, directory server 380 may retrieve any related user information from the directory and transmit the user information to server computing device 350. In this case, access to the social network may be restricted to users (e.g., employees of a company) that have access to the enterprise local area network.

FIG. 4A is a flowchart of an example method 400 for execution by a server computing device 100 for generating and sending social recommendations to a user computing device. Although execution of method 400 is described below with reference to server computing device 100 of FIG. 1, other suitable devices for execution of method 400 may be used, such as server computing device 350 of FIG. 3. Method 400 may be implemented in the form of executable instructions stored on a machine-readable storage medium, such as storage medium 120, and/or in the form of electronic circuitry.

Method 400 may start in block 405 and continue to block 415, where server computing device 100 may perform a file search to identify previously uploaded files that are similar to a file received from a user. For example, a user viewing a social context on a user computing device may upload a file to the server computing device 100 so that the file can be added to the social context. In this example, the server computing device 100 may generate a file checksum for the file and identify previously uploaded files with matching file checksums. In block 420, server computing device 100 may then identify unconnected users that are associated with the previously uploaded files identified in block 415. For example, the unconnected users may be identified because they uploaded the previously uploaded files to related social contexts.

Finally, in block 425, server computing device 100 may send to the user computing device a user recommendation that at least one of the unconnected users be added to the social context by the user. Method 400 may then continue to block 430, where method 400 may stop.

FIG. 4B is a flowchart of an example method 450 for execution by a user computing device 200 for receiving and processing social recommendations from a server computing device. Although execution of method 450 is described below with reference to user computing device 200 of FIG. 2, other suitable devices for execution of method 450 may be used, such as user computing device 300 of FIG. 3. Method 450 may be implemented in the form of executable instructions stored on a machine-readable storage medium, such as storage medium 220, and/or in the form of electronic circuitry.

Method 450 may start in block 455 and proceed to block 460, where user computing device 200 may send a file to the server computing device so that the file can be included in a social context. The file may be a document or media that the user wishes to share with other users in the social context (e.g., conversation, VOIP call, video conference, etc.).

Next, in block 465, user computing device 200 may receive a user recommendation that an unconnected user be added to the social context currently displayed on the user computing device 200. In block 470, user computing device 200 may determine whether the user has confirmed the user recommendation. For example, the user computing device 200 may display a confirmation message requesting that the user either confirm or deny the user recommendation.

Finally, if the user confirms the user recommendation, method 450 may continue to block 475, where user computing device 200 may update the display of the social context to include the unconnected user. Method 450 may subsequently proceed to block 480, where method 450 may stop. Alternatively, when the user does not confirm the recommendation in block 470, method 450 may skip directly to block 480.

FIG. 5A is a flowchart of an example method 500 for execution by a server computing device 350 for providing social recommendations to a user computing device 300. Although execution of method 500 is described below with reference to server computing device 350 of FIG. 3, other suitable devices for execution of method 500 may be used. Method 500 may be implemented in the form of executable instructions stored on a machine-readable storage medium and/or in the form of electronic circuitry.

Method 500 may start in block 505 and proceed to block 510, where server computing device 350 may receive a the to be included in a social context (e.g., conversation, VOIP conference, desktop share, etc.) from a user computing device 300. The user computing device 300 may be currently displaying the social context for a user, where the user uploaded the file to share with other users participating in the social context.

Next, in block 515, server computing device 350 may generate a file checksum for the file received from the user computing device 300 in block 510. The the checksum may be generated by applying a checksum function to the data blocks of the stored file. The checksum function is typically configured to have a high probability of producing a different result when applied to differing data blocks. Accordingly, if two files have matching file checksums, there is a high probability that the stored data blocks of the files are identical. Examples of checksum functions include a parity byte function, a parity word function, a modular sum function, etc.

In block 520, server computing device 350 may generate a compact representation of the file received from the user computing device 300 in block 510. The compact representation generated may be dependent on the file type of the file. For example, a text-based document may be compactly represented based on a vector of word counts. In this example, the compact representation of text-based documents may be enhanced by applying term-weighting retrieval schemes. In another example, a media file may be compactly represented as a feature (e.g., pitch, lightness, etc.) histogram. In either case, the similarity of files may be determined based on the common features (e.g., words, pitch, lightness) shared by the compact representations of the files.

In block 525, server computing device 350 performs a checksum file search to identify previously uploaded files that are identical to the file received in block 510. Specifically, the checksum file search may search for previously uploaded files with corresponding checksums that exactly match the file checksum generated in block 515, where an exact match indicates that the previously uploaded files are identical to the file received in block 510.

In block 530, the server computing device 350 may determine whether the checksum file search identified any matching previously uploaded files. If there is a checksum file match, method 500 may proceed to block 550, where the server computing device 350 identifies unconnected users that are associated with the matched files. For example, the server computing device 350 may identify an unconnected user as having uploaded one of the matched files. In another example, the server computing device 350 may identify an unconnected user as having commented in a social context that includes one of the matched files.

In block 555, the server computing device 350 sends a user recommendation to user computing device 300 that the unconnected users identified in block 550 should be added to the social context currently displayed on the user computing device 300. The user computing device 300 may then confirm the recommendation and update the social context as discussed above with respect to FIG. 4B. Method 500 may then proceed to block 560, where method 500 may stop.

If no checksum file match is found in block 530, method 500 may proceed to block 535, where server computing device 350 performs a compact file search to identify previously uploaded files that are similar to the file received in block 510. The compact file search may search for previously uploaded files with corresponding compact representations that share at least one feature with the compact representation generated in block 520.

In block 540, the server computing device 350 may determine whether the compact file search identified any matching previously uploaded files. If there is a compact file match, method 500 may proceed to block 545, where the matched files may be ranked based on a confidence that each matched file is similar to the file received in block 510. For example, a previously uploaded file that shares numerous features with the file received in block 510 may have a high confidence value because there is a high probability that the previously uploaded file is similar to the received file. In contrast, a previously uploaded file that shares a single feature with the file received in block 510 may have a low confidence value because there is a low probability that the previously uploaded file is similar to the received file.

At this stage, method 500 may proceed to blocks 550-560 as discussed above, except that the social recommendations are generated based on the results of the compact file search rather than the checksum file search. Further, the social recommendations generated in block 555 may be prioritized based on the rankings assigned to the previously uploaded files during the compact file search. In this case, a previously uploaded file with a high confidence value may result in a social recommendation with a high priority whereas a previously uploaded file with a low confidence value may result in a social recommendation with a low priority. Accordingly, the social recommendations may be presented to the user on the user computing device 300 in order from high to low priority such that the user is encouraged to confirm the higher priority recommendations.

After sending the social recommendations to the user in block 555, method 500 may then stop in block 560. Alternatively, when there is no compact file match in block 540, method 500 may proceed directly to block 560, where method 500 may stop.

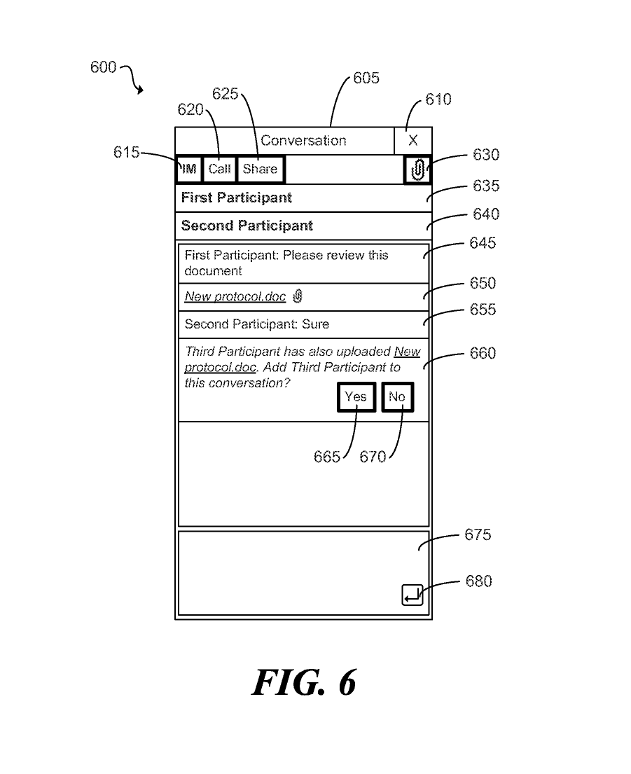

FIG. 6 is a diagram of an example user interface 600 of a social networking application in which a panel including a conversation has been displayed. As depicted, the user interface 600 is displaying a conversation between a First Participant identified in a current user panel 635 and a Second Participant identified in a participating user panel 640. The First Participant may be the user interacting with the user interface 600 in this example.

The user interface 600 also includes a title bar 605 identifying the current social context as a conversation and a close icon 610 that may be used by the First Participant to exit the conversation. The user interface 600 also includes icons for three social context modes: an instant message (IM) icon 615, a call icon 620, and a share icon 625. As depicted, the IM icon 615 is currently active so that the social context is currently in a conversation mode. If selected, the call icon 620 allows the First Participant to initiate a VOIP call with the participants currently in the conversation. Similarly, the share icon 625 allows the First Participant to initiate a desktop sharing session with the participants currently in the conversation.

The user interface 600 has outputted an initial instant message 645 that was submitted by the First Participant using the message entry panel 675 and the message send icon 680. Shown directly below the initial instant message 645, the user interface 600 has outputted an uploaded file 650 that was submitted by the First Participant using a file upload icon 630. The uploaded file 650 may be presented as a link that allows participants of the conversation to access the file. The user interface 600 has also outputted the Second Participant's response in a response instant message 655.

In response to the First Participant providing the uploaded file 650, the user interface 600 has outputted a confirmation message 660 requesting that the user confirm 665 or deny 670 a user recommendation. In this example, the user recommendation recommends that a Third Participant be added to the current conversation because the Third Participant has previously uploaded a file that is identical to the uploaded file 650. If the First Participant confirms 665 the user recommendation, the user interface 600 may be updated to include the Third Participant.

The foregoing disclosure describes a number of example embodiments for providing file-based social recommendations by a server computing device. In this manner, the embodiments disclosed herein enable file-based social recommendations in a social network by identifying similar files and associated users to be added to a social context in response to an uploaded file.

We claim:

1. A system for file-based social recommendations, ions, the system comprising:
a processor to:
search a social network to identify a plurality of uploaded files that are similar to a given file from a user, wherein each of the plurality of uploaded files is associated with a respective social context that is different from a social context associated with the given file;
identify a plurality of unconnected users that each uploaded at east one of the plurality of uploaded files to the social network, wherein each of the plurality of unconnected users is not connected to the user in the social network; and
in response to identifying the plurality of unconnected users, communicate a user recommendation that at least one of the plurality of unconnected users be added to the social context.

2. The system of claim 1, wherein the processor is further configured to:
generate a file checksum for the given file;
wherein the search of the social network is performed using the file checksum to identify the plurality of uploaded files, and wherein each of the plurality of uploaded files has a respective file checksum that matches the file checksum.

3. The system of claim 1, wherein the processor is further configured to:
generate a compact representation for the given file;
wherein the search of the social network is performed using the compact representation to identify the plurality of uploaded files, and wherein each of the plurality of uploaded files has a respective compact representation that shares at least one feature with the compact representation of the given file.

4. The system of claim 3, wherein the processor is further configured to:
determine a file type of the given file; and
select a compact representation scheme based on the file type, wherein the compact representation type includes at least one of a minhash-based signature scheme, a locality sensitive hashing scheme, and a vector-based word scheme;
wherein the compact representation is generated using the compact representation scheme.

5. The system of claim 4, wherein the processor is further configured to:
assign a rank to each of the plurality of uploaded files based on a respective confidence value obtained during the search of the social network, wherein the respective confidence value of each of the plurality of uploaded files is an estimated probability that an uploaded the is similar to the given file;
wherein the user recommendation is assigned a priority based on the rank of the uploaded file.

6. The system of claim 1, wherein the processor is further configured to:
communicate a context recommendation that the user join the respective social context of at least one of the plurality of uploaded files.

7. The system of claim 1, wherein the processor is further configured to:
communicate a file recommendation that the user add at least one of the plurality of uploaded files to the social context.

8. The system of claim 1, wherein the plurality of unconnected users are identified using a directory service, and wherein the social network is restricted to an enterprise local area network.

9. A method for providing file-based social recommendations on a computing device, the method comprising:
searching a social network to identify a plurality of uploaded files that are similar to a given file from a user, wherein each of the plurality of uploaded files is associated with a respective social context that is different from a social context associated with the given file;
using a directory service to identify a plurality of unconnected users that each uploaded at least one of the plurality of uploaded files to the social network, wherein each of the plurality of unconnected users is not connected to the user in the social network; and
communicating, in response to identifying the plurality of unconnected users, a user recommendation that at least one of the plurality of unconnected users be added to the social context.

10. The method of claim 9, further comprising:
generating a compact representation for the given file;
wherein searching comprises using the compact representation to identify the plurality of uploaded files, and wherein each of the plurality of uploaded files has a respective compact representation that shares at least one feature with the compact representation.

11. The method of claim 10, further comprising:
determining a file type of the given file; and
selecting a compact representation scheme based on the file type, wherein the compact representation type includes at least one of a minhash-based signature scheme, a locality sensitive hashing scheme, and a vector-based word scheme;
wherein the compact representation is generated using the compact representation scheme.

12. The method of claim 11, further comprising:
assigning a rank to each of the plurality of uploaded files based on a respective confidence value obtained during the search of the social network, wherein the respective confidence value of each of the plurality of uploaded files is an estimated probability that an uploaded file is similar to the given file;
wherein the user recommendation is assigned a priority based on the rank of the uploaded file.

13. A non-transitory machine-readable storage medium encoded with instructions executable by a processor, the machine-readable storage medium comprising:
instructions for communicating a given file to a server computing device, wherein the given file is associated with a first social context in a social network;
instructions for receiving a user recommendation that at least one of a plurality of unconnected users be added to the first social context, wherein each of the plurality of unconnected users is not connected to the user in the social network, and wherein each of the plurality of unconnected users uploaded at least one of a plurality of uploaded files that are similar to the given file; and
instructions for updating, in response to receiving confirmation of the user recommendation, a context display of the first social context to include an unconnected user of the plurality of unconnected users;
wherein the plurality of uploaded files are identified as being similar to the given file by determining that a compact representation of the given file shares at least one feature with a respective compact representation of each of the plurality of uploaded files.

14. The machine-readable storage medium of claim 13, further comprising instructions for:
receiving a context recommendation that the user join a second social context associated with one of the plurality of uploaded files; and
in response to receiving confirmation of the context recommendation, displaying the second social context including the user.

15. The machine-readable storage medium of claim 13, further comprising instructions for:
receiving a file recommendation to add an uploaded file of the plurality of uploaded files to the first social context; and
in response to receiving confirmation of the recommendation, updating the context display of the first social context to include the uploaded file.
